(19) United States
(12) Patent Application Publication
(10) Pub. No.: US 2014/0078178 A1
(43) Pub. Date: Mar. 20, 2014

(54) Adaptive Display Of A Visual Object On A Portable Device

(71) Applicant: Eric Qing Li, Dallas, TX (US)

(72) Inventor: Eric Qing Li, Dallas, TX (US)

(73) Assignee: Eric Qing Li, Dallas, TX (US)

(21) Appl. No.: 13/619,878

(22) Filed: Sep. 14, 2012

(51) Int. Cl. G09G 5/00

(52) U.S. Cl. 345/659

(57) ABSTRACT

The present disclosure involves a method of configuring a visual display. The method includes: receiving a first request to display a visual object; displaying the visual object on a portable electronic device; detecting whether a landscape orientation or a portrait orientation is used during the displaying of the visual object in response to the first request; receiving a second request to display the visual object, the second request occurring after the first request; performing, in response to the second request, one of the following actions based on the detecting: if the landscape orientation is used during the displaying of the visual object in response to the first request, displaying the visual object in the landscape orientation by default; and if the portrait orientation is used during the displaying of the visual object in response to the first request, displaying the visual object in the portrait orientation by default.

### BACKGROUND

1. Technical Field

The present disclosure generally relates to configuring the display of a visual object on a portable electronic device.

2. Related Art

In recent years, the rapid advances in computer technology and broadband telecommunications have enhanced the popularity of portable electronic devices such as tablet computers and mobile telephones. Among other uses, these portable electronic devices have been often used to view visual objects such as webpages, pictures, or videos. However, existing portable electronic devices may still have certain drawbacks with respect to viewing or displaying the visual objects. For example, most portable electronic devices can display a visual object in either a portrait orientation or a landscape orientation. But the user may have to frequently switch the orientation of a displayed visual object to a different orientation. This is a cumbersome process and may frustrate the user.

Therefore, while existing portable electronic devices have been generally adequate for their intended purposes, they have not been entirely satisfactory in every aspect. It would be advantageous to add, among other things, more intuitive orientation detection and switching capabilities to portable electronic devices.

### BRIEF DESCRIPTION OF THE DRAWINGS

FIGS. 1-14 are example diagrammatic views of a portable electronic device according to various aspects of the present disclosure.

FIG. 15 is a simplified block diagram of an example portable electronic device according to various aspects of the present disclosure.

FIG. 16 are simplified block diagrams of various embodiments of a system according to various aspects of the present disclosure.

FIG. 17 is an example method for configuring the display of a visual object on a portable electronic device according to various aspects of the present disclosure

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity. In addition, the present disclosure may repeat reference numerals and/or letters in the various examples. This repetition is for the purpose of simplicity and clarity and does not in itself dictate a relationship between the various embodiments and/or configurations discussed

In recent years, the rapid advances in computer technology and broadband telecommunications have led the growing popularity of portable electronic devices such as tablet computers and mobile telephones. A user of these portable electronic devices can perform a plurality of tasks on these portable electronic devices, for example tasks that previously required a conventional desktop or laptop computer. Among other things, a user can play movies/videos, browse the web, play games, view photographs, listen to digital music, read e-books, receive navigational instructions, send and receive emails, conduct audio or video telephone calls, perform word processing/spreadsheet calculation/Attorney presentation management tasks, or take advantage of additional functionalities offered by applications (apps) that can be downloaded from online app stores.

However, the portable electronic devices may still have certain drawbacks. For example, most portable electronic devices are shaped similar to a rectangle and therefore allow a visual object such as a webpage to be displayed either in a portrait orientation mode or in a landscape orientation mode. To switch between these two orientation modes, conventional portable electronic devices use sensors such as accelerometers to detect the manner in which the portable electronic device is positioned, so that a corresponding orientation mode can be applied. After a user-specified orientation has been detected, the portable electronic device may then adjust the display of the visual object to comply with the user-specified orientation. To prevent inadvertent orientation switching, the user may also have to “lock” the orientation for the portable electronic device. Thus, if the user is presented with a different visual object that is better suited for another orientation, the user may have to first unlock the orientation, then switch the orientation (for example by rotating the portable electronic device), and lock the orientation again after a new target orientation has been achieved. This is a cumbersome and repetitive process and may lead to a frustrating user experience with using the portable electronic device.

According to the various aspects of the present disclosure, methods and apparatuses for adaptively displaying visual objects according to a desired orientation are disclosed, as discussed in more detail below.

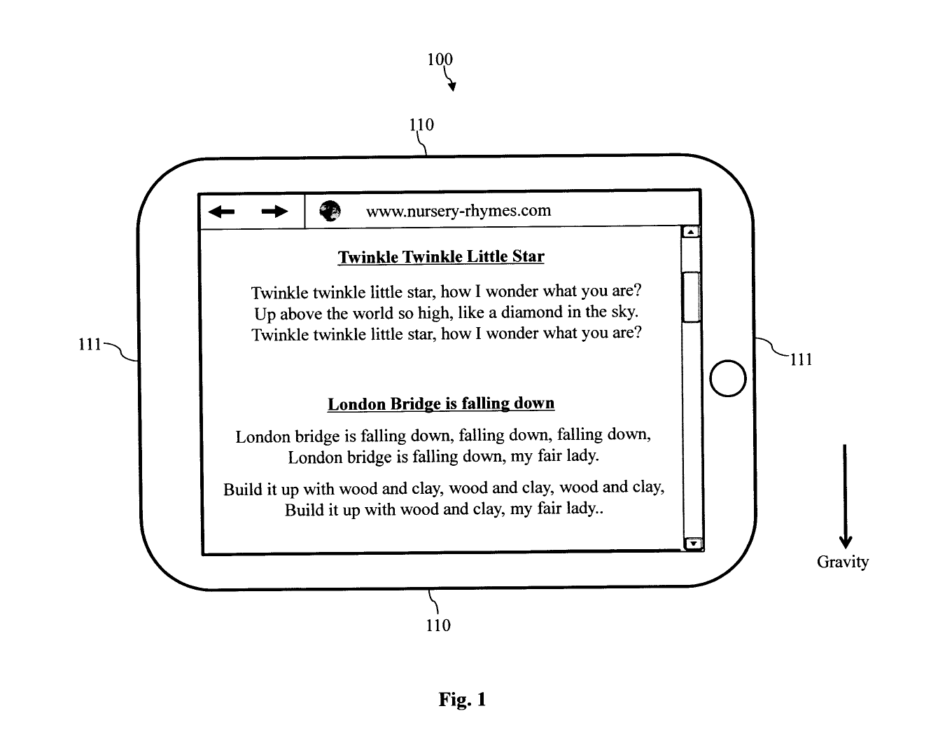

Referring to FIG. 1, a simplified diagrammatic view of a portable electronic device 100 is illustrated. In some embodiments, the portable electronic device 100 may be a tablet computer (for example, APPLE's® IPAD® or various ANDROID® or WINDOWS® powered tablets) or a mobile telephone (for example, APPLE's® IPHONE® or various ANDROID® or WINDOWS® powered smart-phones). The portable electronic device 100 may be approximately shaped as a rectangle, in that it has two long sides 110 and two short sides 111. As such, the portable electronic device may be oriented in either a landscape orientation (e.g., a long side 110 at the bottom) or a portrait orientation (e.g., a short side 111 at the bottom).

In some embodiments, the portable electronic device 100 may include a touch-sensitive display (or touch screen) for displaying one or more visual objects. However, it is understood that the various aspects of the present disclosure may apply to a non-touch screen display as well. For example, whereas a touch screen device may detect user input via sensing the contact and the movement of the user's fingers on the touch screen, a non-touch screen device may detect user input via more traditional mechanisms such as a mouse, a keyboard, a remote control, a gesture, a stylus, or voice commands.

The visual object displayed on the portable electronic device may include, but is not limited to, webpages, digital pictures, digital videos, or a home screen of the portable electronic device, where the home screen specifies the layout of a plurality of icons. In the embodiment illustrated in FIG. 1, the portable electronic device 100 receives a request (for example from a user) to display an example webpage www.nursery-rhymes.com as a visual object. The contents of the web page are displayed on the screen of the portable electronic device via a web browser. As non-limiting examples, the request may be received when the user inputs the target Universal Resource Locator (URL) link to an address bar of the web browser, or when the user clicks on a link in another web page. For the sake of providing an example, the words of two well-known nursery rhymes “Twinkle twinkle little star” and “London bridge is falling down” are shown as a portion of the example webpage.

In the embodiment shown in FIG. 1, the portable electronic device 100 is configured to display the visual object (i.e, the webpage) in a landscape orientation. This is done in response to a request from a user. The user may specify the landscape orientation as a desired orientation by interacting with the portable electronic device in a certain manner. For example, the portable electronic device may include one or more sensors, such as a gravity sensor or an accelerometer. Supposed the portable electronic device is held by the user in a position such that one of the long sides 110 is closer to the ground (where the gravity is pulling the portable electronic device 100 toward the ground, as indicated by the downward arrow). The portable electronic device 100 may detect this position of the portable electronic device via its sensors. The portable electronic device 100 may interpret the user action as that the user would like to display the visual object in the landscape orientation. Thus, the portable electronic device 100 may display the visual object (the webpage) in the landscape orientation. The user may or may not have locked the portable electronic device 100 in the landscape orientation mode at this time.

The portable electronic device 100 (or the operating system or an application running on the portable electronic device 100) may establish an association between the display of this particular visual object with the landscape orientation. The portable electronic device 100 may store such association in an electronic storage, which may be local to the portable electronic device 100 itself, or in one or more computer servers remote to the portable electronic device 100. In some embodiments, the association between the display of the visual object and the particular orientation (landscape orientation in this case) is stored as an electronic database entry. This orientation (the landscape orientation in this example) may be said to be a user-preferred orientation for the displaying of this particular visual object.

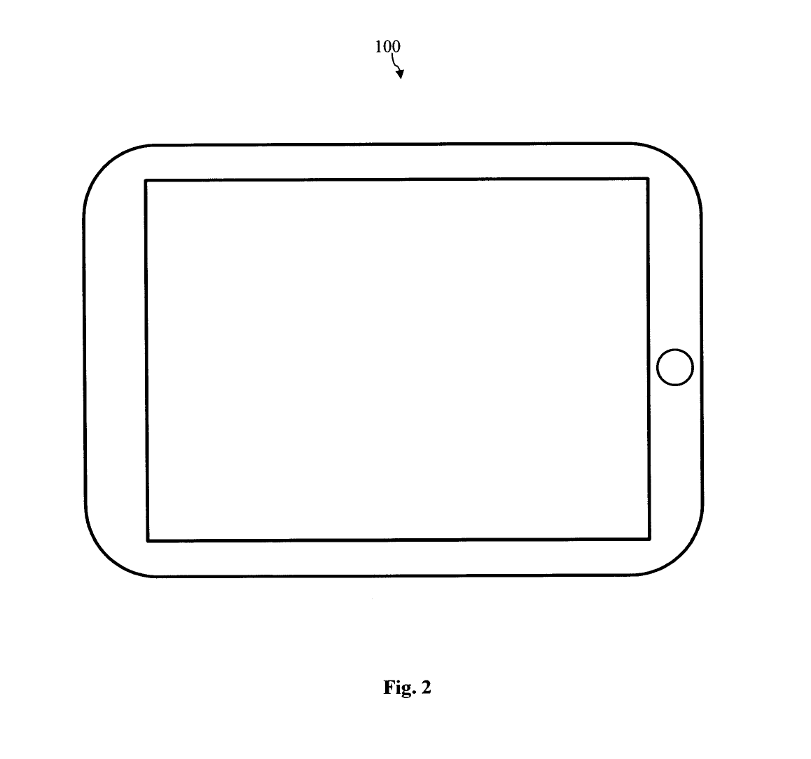

Referring now to FIG. 2, the visual object is cleared out of a cache memory. In some embodiments, the cache memory is a temporary storage medium on the portable electronic device 100. In general, cache memory refers to a digital memory storage element of a computing device that is configured to temporarily store certain files. “Caching” files allows files to be retrieved more quickly for future requests. In the context discussed herein, the visual object may or may not have been cached in the first place. If the visual object had not been cached, then no specific steps are performed to clear the visual object out of the cache memory.

However, in instances where the visual object had been cached at some point in time, it may be un-cached (or cleared out of cache memory) by one of a plurality of events. For example, the visual object may be cleared out of cache memory if the portable electronic device 100 is shut down (or turned off), as shown in FIG. 2. In that case, the cache memory of the portable electronic device is typically cleaned or cleared, and thus the visual object is no longer stored in the cache memory of the portable electronic device 100. When the portable electronic device 100 is booted up again, its cache memory is empty. In some other instances, the visual object may be cleared out of cache memory if an application containing the visual object has been exited or closed. For example, if the web browser (e.g., SAFARI®, CHROME®, FIREFOX®, etc.) in which the webpage is displayed is closed or exited, the visual object (i.e., the contents of the webpage) may be cleared out of the cache memory as well. In yet other instances, the visual object may be cleared out of cache memory simply by a passage of time. If a sufficiently long period of time has elapsed, for example a few hours, a few days, or a few weeks or months, the visual object may be cleared out of cache memory, even if the portable electronic device is remains turned on the entire time, and the application containing the visual object has not been closed or exited.

Though the discussions above use cache memory on the portable electronic device 100 itself as an example, it is understood that in some instances, the cache memory may refer to a remote storage medium capable of temporarily storing the visual object, for example a remote computer server in a cloud computing environment.

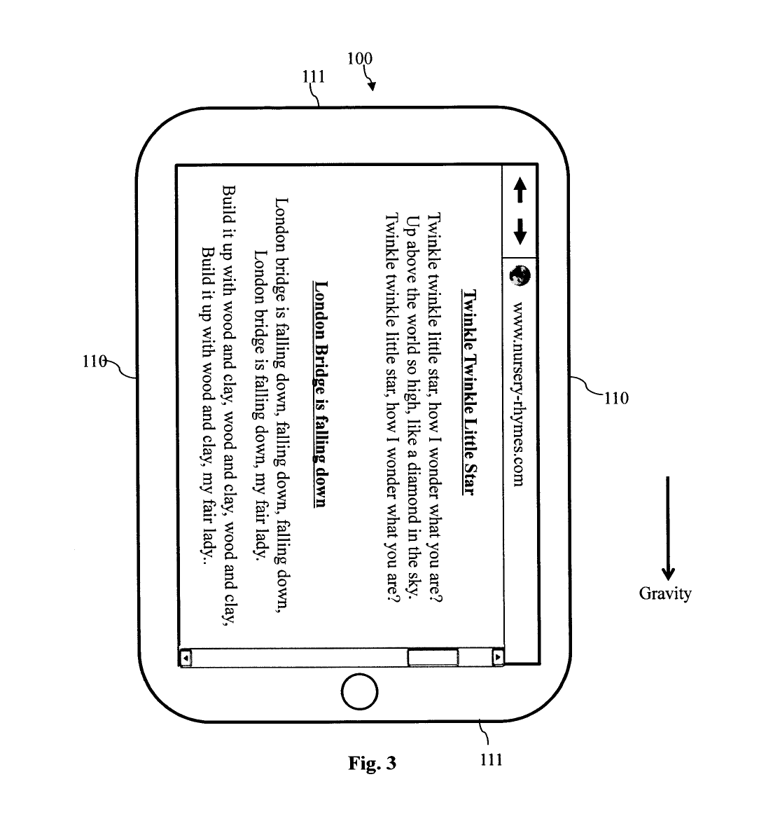

Referring now to FIG. 3, at some time after the visual object is cleared out of cache memory, the portable electronic device 100 receives another request to display the same visual object. Once again, the request may be received from the user, who may be making the request by inputting the web address of the webpage or by clicking on a link to the webpage. In any case, the portable electronic device 100 displays the visual object in response to the user request. Note, however, that the portable electronic device 100 has been oriented in a new position, such that one of its shorter sides 111 is now closer to the ground. If the orientation mode has not been locked, conventional portable electronic devices would have sensed its new position by way of sensors, and therefore would “assume” that the user would want to display the visual object in a portrait mode. In reality, this may or may not have been the user's true intention.

For example, the user may have forgotten to lock down the orientation mode to the landscape mode (i.e., the portable electronic device is un-locked orientation-wise). The new position of the portable electronic device may be due to an inadvertent movement, as an example. Nevertheless, the user would still prefer to view the visual object in the landscape orientation. Under the conventional scheme, the user would have to rotate the portable electronic device until the landscape orientation is applied, and then lock the orientation to prevent further inadvertent orientation switching.

As another example, the user may have been viewing a different visual object in the portrait orientation (for example after the webpage has been cleared out of cache memory). To prevent inadvertent orientation switching, the user actually locks down the display orientation of the portable electronic device. After the user is done with viewing the other visual object, the user now wishes to view the webpage visual object shown herein. However, he would have to perform several steps to get the web page displayed in the landscape orientation again. First, the user needs to unlock the display orientation of the portable electronic device. Second, the user needs to rotate the portable electronic device until the landscape orientation has been achieved. Next, the user may have to lock down the display orientation of the portable electronic device again to prevent further inadvertent movements. These steps are cumbersome and repetitive and may frustrate the user.

According to the various aspects of the present disclosure, however, the user need not be burdened with these problems discussed above. Since the user-preferred orientation (i.e., the landscape orientation) of the visual object has been recorded or otherwise “remembered” by the portable electronic device 100 (or retrieved from a remote storage), the portable electronic device 100 can automatically display the visual object again under the “user-preferred” orientation—the landscape orientation. Thus, the portable electronic device 100 will now apply the landscape orientation as a default orientation to the display of the visual object. This is done even though the portable electronic device itself may be held in a way so as to suggest a portrait orientation should be applied.

In other words, in a situation where the display orientation is currently unlocked, a landscape orientation is applied to the webpage as it is displayed, even though the sensors of the portable electronic device 100 may suggest that the portrait orientation should have been applied. And in a situation where the display orientation is currently locked in a portrait mode (e.g., because the user was viewing another object in a portrait mode prior to the web page is displayed again), the portable electronic device 100 is still “smart” enough to apply the landscape orientation to the displaying of the webpage, because it “knows” that the landscape orientation is the orientation preferred by the user while viewing this particular visual object. Again, this task discussed above may be accomplished by the previously-stored association between the display of the particular visual object and its user-preferred orientation mode.

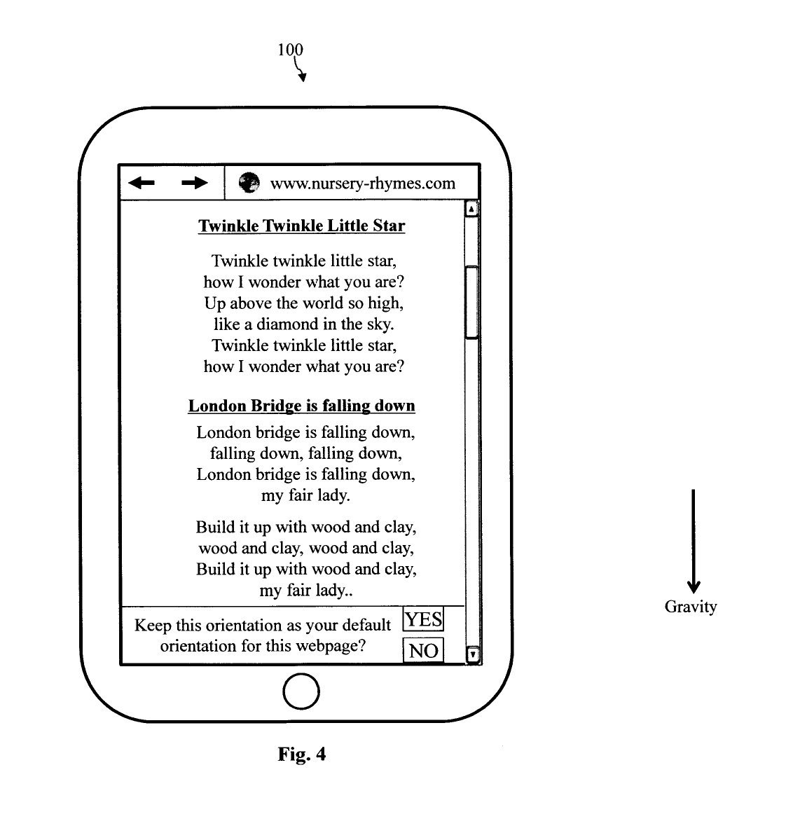

The same is true had the user preferred the portrait orientation for the visual object. Referring now to FIG. 4, suppose that the user had initially positioned the portable electronic device 100 in a manner so that the same webpage visual object had been displayed in the portrait orientation. In response to this event, the portable electronic device 100 or a remote server would then estimate that the user-preferred orientation mode for this particular visual object (i.e., the webpage) is the portrait orientation. Consequently, the portable electronic device 100 (or its operating system or an application running thereon) will now associate the visual object with the portrait orientation. The portable electronic device 100 will apply the portrait orientation to subsequent displays of the visual object as its default orientation, regardless of other orientation modes that may be suggested by the sensors.

Of course, the default orientation mode for the visual object can be easily overridden or corrected by the user if it does not reflect the user's true intention. For example, in some embodiments, such as the one shown in FIG. 4, the portable electronic device 100 may display a message “Keep this orientation as your default orientation for this webpage?” and prompt the user to choose “YES” or “NO.” If the user chooses “YES”, then the previously-stored user-preferred orientation—in this case the portrait orientation—will be used as the default orientation for future displays of this webpage (or another particular visual object). If the user chooses “NO”, then the portable electronic device 100 may remove the association between the previously-stored user-preferred orientation mode and the webpage, and may display the webpage according to an orientation under normal circumstances, for example.

In yet other embodiments, the user can choose to disassociate the previously-stored user-preferred orientation with the visual object by performing other actions. For example, the user may shake the portable electronic device 100 in order to exit out of whatever orientation applied to the visual object, and to disassociate that orientation with future displays of the visual object. As another example, the user may hold the portable electronic device 100 in a selected position for a time period exceeding a predefined amount of time, in order to apply an orientation that would have been recommended by the sensors of the portable electronic device 100 to the visual object.

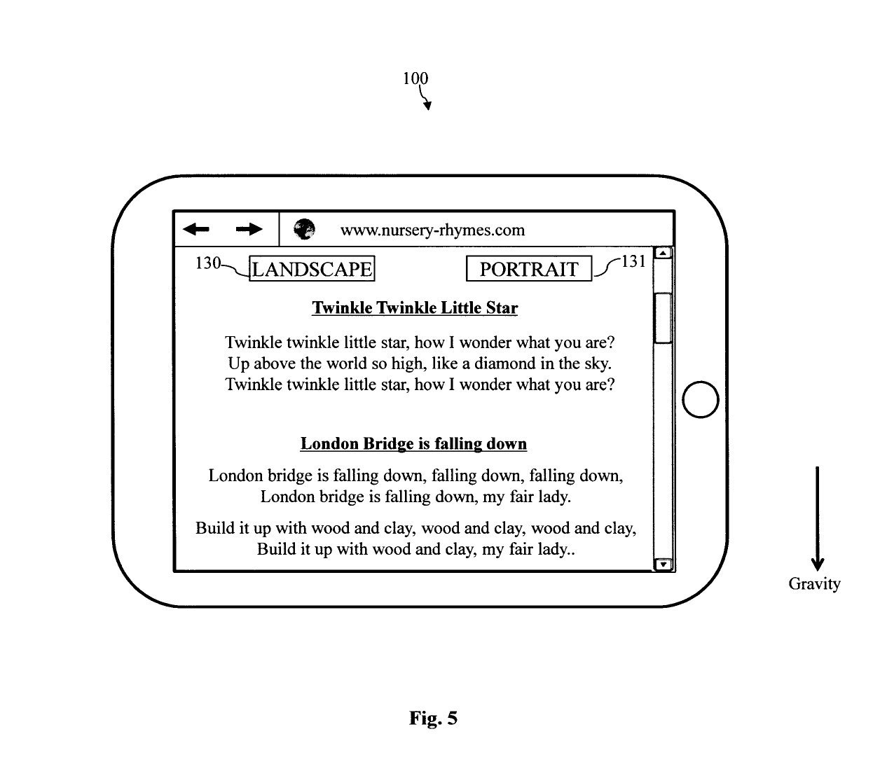

In yet other embodiments, the portable electronic may explicitly prompt the user to pick an orientation mode for the display of a visual object. An example of this is shown in FIG. 5, where the portable electronic device 100 may display virtual mechanisms such as buttons 130 and 131 in a web browser to let the user choose between a landscape orientation and a portrait orientation for the visual object. In some embodiments, these virtual mechanisms may be displayed on-screen, or they may be normally hidden but can be triggered by selecting the correct menu items. And though not specifically shown for reasons of simplicity, the user may also be allowed to specify whether the selected orientation should be applied only one time, or whether the selected orientation should be associated with the particular visual object as a user-preferred orientation, so that future displays of the visual object should have the user-preferred orientation applied thereto.

In some embodiments, the portable electronic device 100 (or its operating system or an application running thereon) does not automatically predict a user-preferred orientation for a visual object after the visual object has been detected to be oriented in that orientation mode just one time. Instead, the visual object has to be oriented in a particular orientation mode a plurality of times before the user-preferred orientation mode is associated with the visual object. For example, suppose the portable electronic device 100 has detected this pattern: for the past ten times the user has accessed or displayed a particular webpage, a landscape orientation is used for every single one of them. That is a good indication that the user strongly prefers the landscape orientation for the display of this particular webpage. Based on this detected pattern, the portable electronic device 100 may then designate (with a high confidence level) the landscape orientation as the user-preferred orientation for this webpage, and automatically apply the landscape orientation to the webpage as a default orientation for its future displays. Meanwhile, the portable electronic device 100 may be configured to not estimate or associate a user-preferred orientation with other visual objects that have not been accessed a plurality of times (less than the predefined number).

In some embodiments, the portable electronic device 100 does not necessarily designate or apply the user-preferred orientation to every visual object. Instead, the user-preferred orientation discussed above may be designated and applied only to a selected subset of visual objects. For instance, some visual objects may be accessed or displayed much more frequently than others. As an example, the user may log on to a particular website www.example.com every day or multiple times a day. The user may also consistently choose to display this website in a particular orientation. The pattern of the user accessing such visual object (www.example.com) and displaying it in the particular orientation may be detected by the portable electronic device 100, which may deem the visual object as a frequently-accessed or frequently-displayed visual object. Consequently, the portable electronic device 100 may predict the user-preferred orientation for this visual object and then subsequently display the visual object in the user-preferred orientation. To qualify as a frequently-accessed or frequently displayed visual object, the target visual object may need to be accessed for more than an X number of times within a Y period of time (for example at least 5 times in 3 days). Meanwhile, the portable electronic device 100 may not estimate or associated a user-preferred orientation with other visual objects that have not met this qualification.

These embodiments discussed above may lessen the burden placed on the portable electronic device 100 in terms of having to track the display and orientation of all the visual objects. Nonetheless, the user's needs are still served well because the frequently-accessed or frequently-displayed visual objects are the visual objects that the user cares more about.

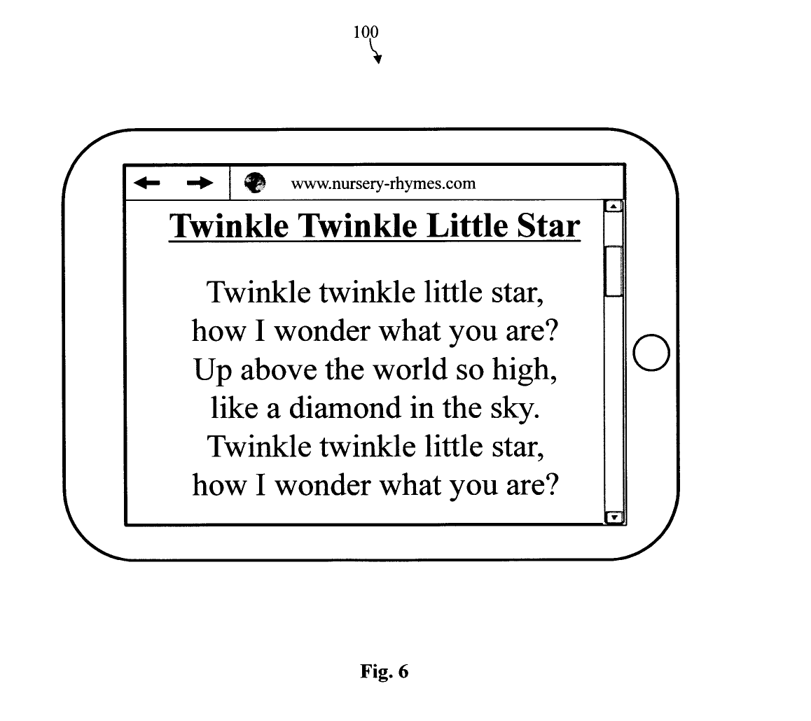

According to other various aspects of the present disclosure, the portable electronic device 100 (or its software) may also detect and “remember” a user-preferred zooming level for a visual object. This user-preferred zooming level may also be applied to a subsequent display of the visual project even after the visual object has been cleared out of cache memory. For example, referring now to FIG. 6, the example visual object illustrated is still the webpage www.nursery-rhymes.com. However, the contents of the webpage have been displayed in a zoomed-in state in response to user request. In other embodiments, the user may specify any zooming level when viewing a visual object. The zooming level chosen by the user may be pleasing to the eye of the user, or may convey the right amount of information to the user. Regardless of the reason, the portable electronic device 100 may detect this specific zooming level applied to the visual object when it is displayed. The portable electronic device 100 may also deem this zooming level as a user-preferred zooming level for the visual object and apply the zooming level to future displays of the visual object. Therefore, in a manner similar to the configuring of the orientation of a visual object, the zooming level of the visual object may also be detected and associated with the visual object as a user-preferred zooming level, which is then automatically applied as a default zooming level to the visual object when it is displayed in the future.

The user-preferred zooming level detection/association/application for a visual object may be particularly useful for smaller portable electronic devices 100, for example smart phones. This is due to the small screen real estate on a smart phone versus a tablet computer. Due to the smaller screen real estate, it may be harder to see a visual object in its entirety as it is initialed loaded and displayed. For example, a webpage displayed on a smart phone may require the user to zoom in (which may also cause the contents of the webpage to be re-arranged) before its content can be legible for the user. With conventional smart phones, if the user is a frequent user of that webpage, he/she may need to perform the zooming operation to the webpage every time it is accessed and displayed on the user's smart phone. This is inconvenient and delays the user's viewing of the webpage. In comparison, the user may now be able to set a user-preferred zooming level to the webpage, so that the webpage is displayed according to the user-preferred zooming level in the future every time it is loaded. This saves the user the hassle of having to perform the zooming operation.

It is understood that the other aspects of the user-preferred orientation detection/association/application may also apply to the user-preferred zooming level. For example, in some embodiments, similar to the case in orientation, the zooming level may be deemed to be a user-preferred zooming level only after the visual object has been zoomed to that level (or close to that level) for more than a predefined number of times. As another example, in some embodiments, the automatic zooming operation discussed above is performed only for frequently-zoomed visual objects. To qualify as a frequently-zoomed visual object, the visual object may have to have been zoomed to a particular level (or close to that level) for an X number of times within a Y period of time. Stated differently, the zooming level for a visual object need not be automatically deemed important or user-preferred, until a certain set of criteria has been met. Once again, this may help conserve system resources while also maintaining user satisfaction.

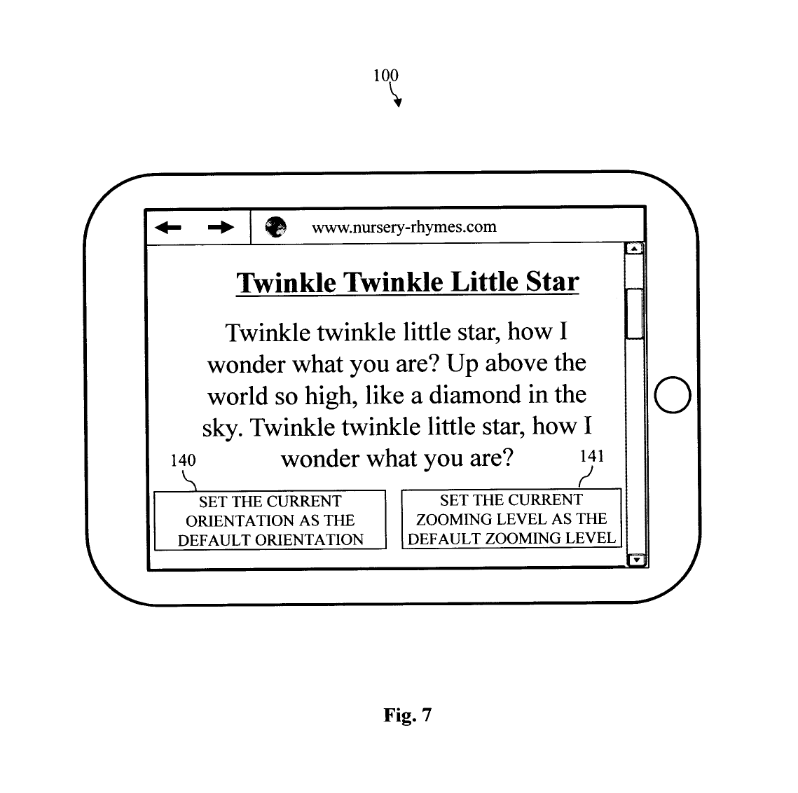

It is also understood that the user may also manually set a preferred orientation mode or a user-preferred zooming level to a visual object, rather than waiting to have the portable electronic device detect and predict such user preferences. For example, referring to FIG. 7, the portable electronic device 100 may display on-screen virtual mechanisms, such as buttons 140 and 141 that respectively read, “Set the current orientation as the default orientation” and “Set the current zooming level as the default zooming level.” If the user clicks on the button 140, the current display orientation is set as the user-preferred orientation mode for the visual object that is displayed. If the user clicks on the button 141, the current zooming level is set as the user-preferred zooming level for the visual object that is displayed.

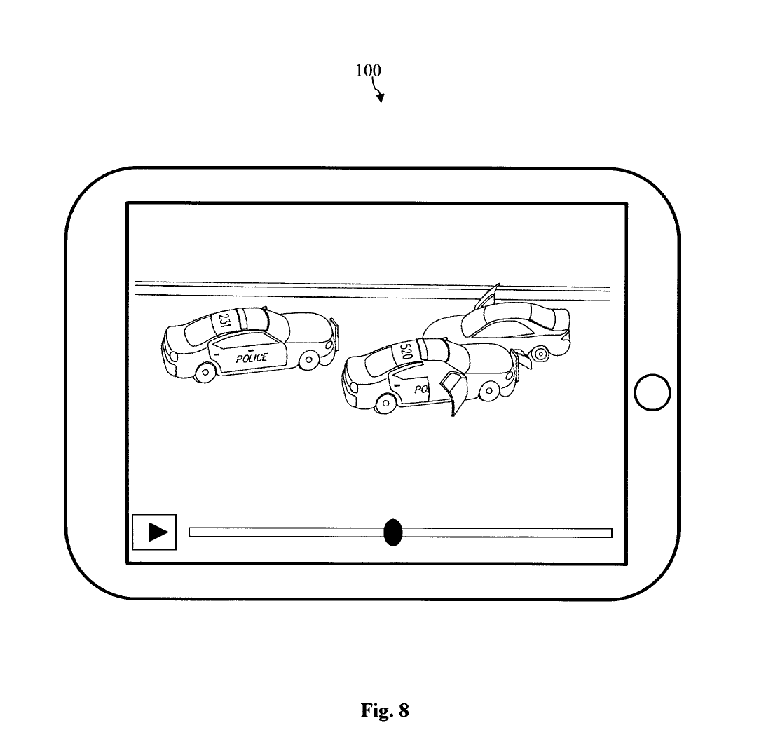

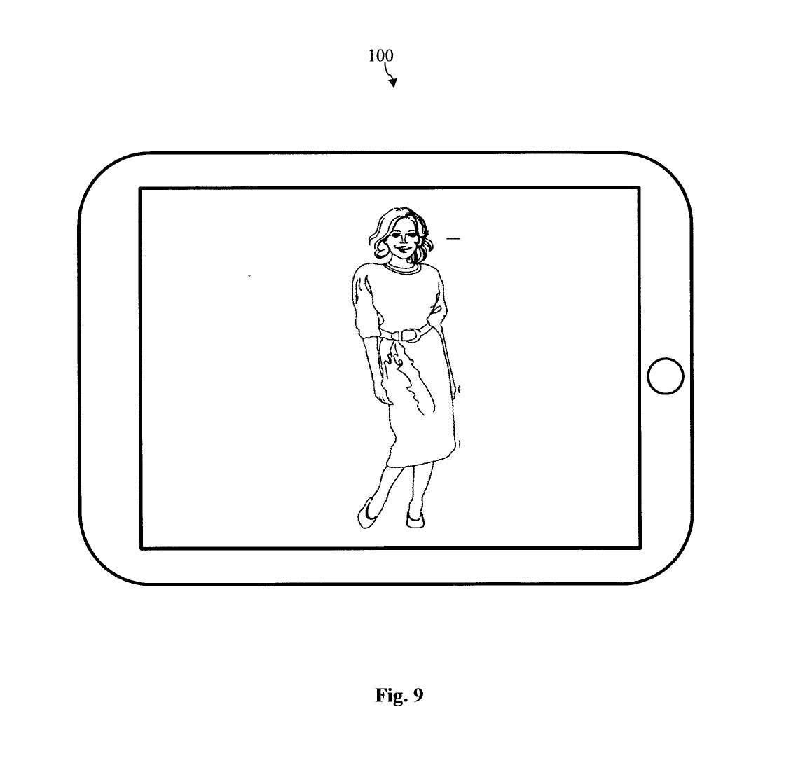

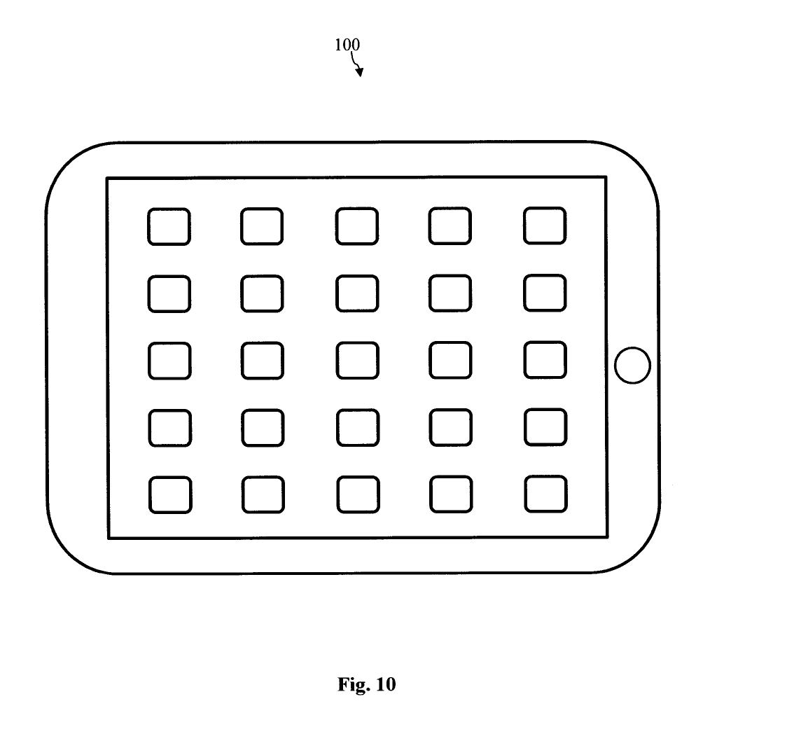

Although the discussions above use a webpage as an example of a visual object, it is understood that visual objects are not limited to webpages. For example, visual objects may include a video (an example scene of which is shown in FIG. 8), a picture (an example of which is shown in FIG. 9), or a home screen layout (an example of which is shown in FIG. 10) that specifies the arrangements of a plurality of icons or widgets.

According to the various aspects of the present disclosure, each user may also interact with a given portable electronic device under separate user profiles. For example, a user may create a first profile for himself, a second profile for his/her spouse, and a third profile for his/her child. Since each person (corresponding to one of the profiles) may have different viewing preferences from other people even when viewing the same visual object, these different viewing preferences are taken into account by the present disclosure as well. For example, a husband may prefer to view a particular webpage in a landscape orientation mode accompanied by an X amount of zooming, while a wife may prefer to view the same webpage in a portrait orientation mode accompanied by no zooming. In that scenario, the portable electronic device 100 may perform the above user-preference (with respect to display orientation and zooming) detection/association/application steps only for a given profile.

For example, if the webpage is accessed a plurality of times under the husband's user profile, the user-preference (if any) with respect to display orientation and zooming of the webpage will be made only for the husband's profile, and not for the wife's profile. If a subsequent access to the webpage is under the wife's profile, the portable electronic device 100 will not automatically retrieve the husband's display orientation and zooming level preferences for that webpage, because the wife may not like those settings. In this manner, the present disclosure allows a set of preferences (for display orientation and zooming) to be remembered and applied separately and individually for each profile of the user, which further enhances user satisfaction.

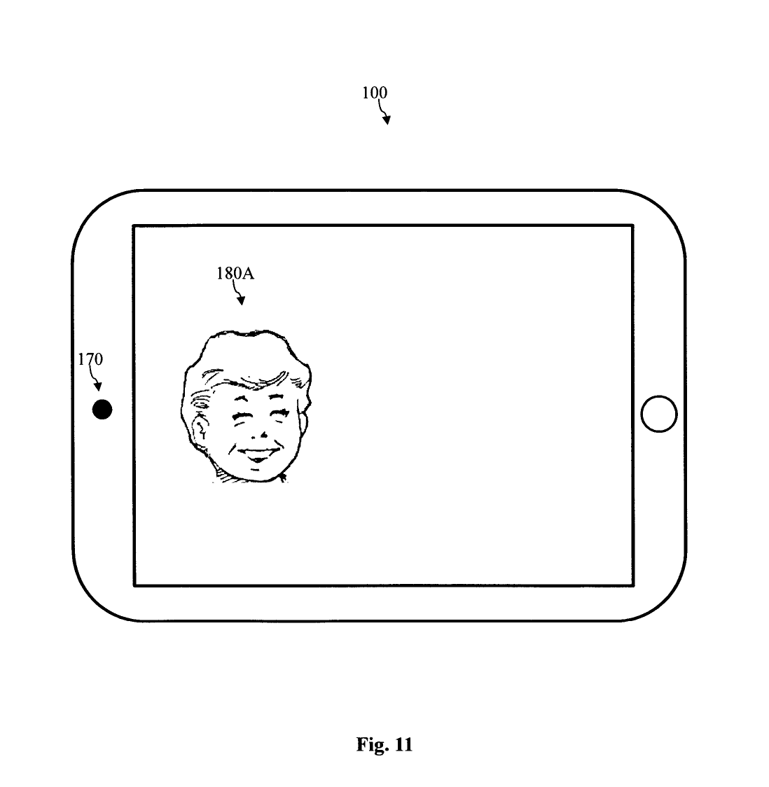

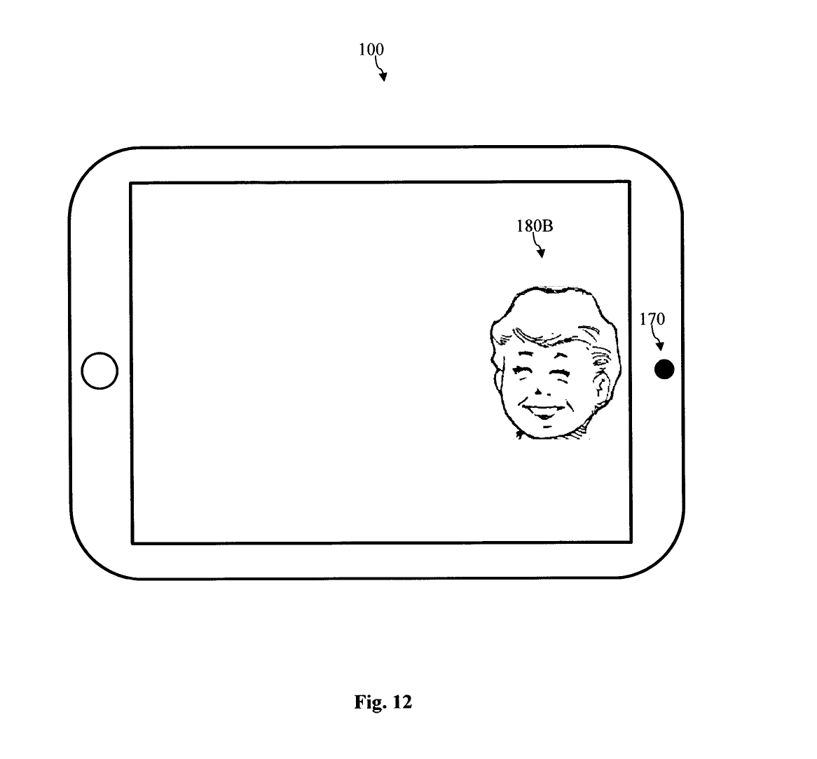

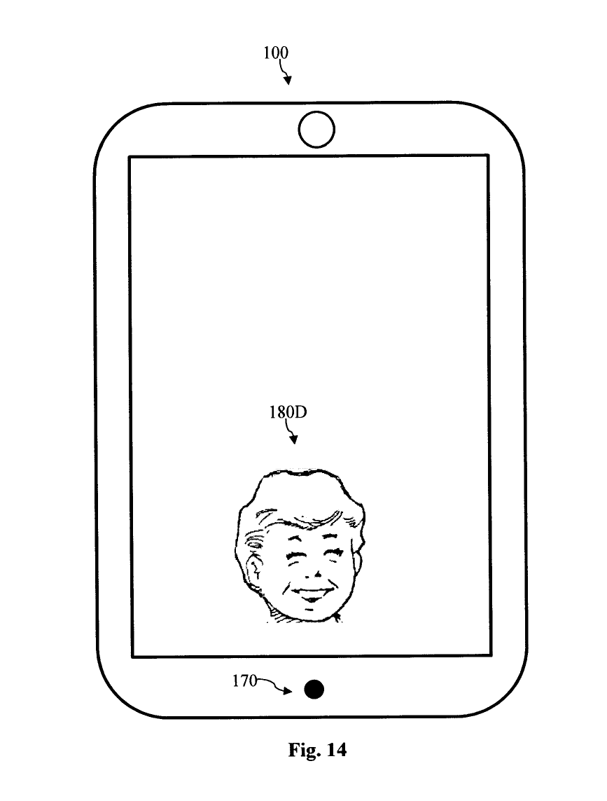

According to other aspects of the present disclosure, the portable electronic device 100 may use an integrated image sensor (such as a camera) to further facilitate the adaptive orientation switching discussed above. Referring to FIGS. 11-14, the portable electronic device 100 may include a front-facing camera 170 as an image sensor. The front-facing camera 170 may capture images of the user, for example facial images 180A-180D of the user that are shown in FIGS. 11-14, respectively. In some embodiments, these facial images 180A-180D of the user are taken by the front-facing 170 without the user's express notice or awareness. In other words, the user need not know that his/her picture is taken. These facial images 180A-180D of the user are then processed and analyzed by the portable electronic device 100.

It can be seen that a specific orientation of the portable electronic device 100 corresponds to a particular location and orientation of the user's facial image 180. By doing image recognition analysis, the portable electronic device 100 may determine the position in which the portable electronic device 100 is held by the user. In some embodiments, the positional information of the portable electronic device 100 may be used to assist in the orientation switching discussed above. For example, if the retrieved user-preferred orientation is a landscape orientation, and the positional information for the portable electronic device indicates that it is held in a landscape mode, then the combination of these two pieces of information will allow the portable electronic device to make a decision (regarding what orientation to use) with a higher confidence level.

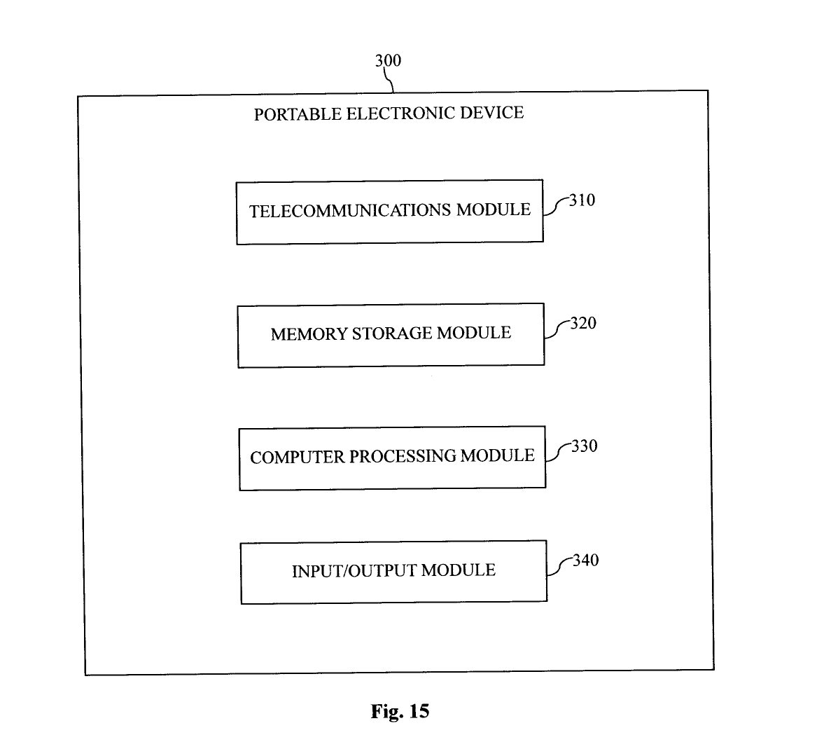

FIG. 15 is a simplified block diagram of an electronic device 300 according to the various aspects of the present disclosure. The electronic device 300 may be implemented as an embodiment of the portable electronic device 100 discussed above.

The electronic device 300 includes a telecommunications module 310. The telecommunications module 310 contains various electronic circuitry components configured to conduct telecommunications with one or more external devices. The electronic circuitry components allow the telecommunications module 310 to conduct telecommunications in one or more of the wired or wireless telecommunications protocols, including communications protocols such as IEEE 802.11 (WiFi), IEEE 802.15 (Bluetooth), GSM, CDMA, LTE, WIMAX, DLNA, HDMI, etc. In some embodiments, the telecommunications module 310 includes antennas, filters, low-noise amplifiers, digital-to-analog (DAC) converters, analog-to-digital (ADC) converters, and transceivers. The transceivers may further include circuitry components such as mixers, amplifiers, oscillators, phase-locked loops (PLLs), and/or filters. Some of these electronic circuitry components may be integrated into a single discrete device or an integrated circuit (IC) chip.

The electronic device 300 may include a computer memory storage module 320. The memory storage module 320 may contain various forms of digital memory, such as hard disks, FLASH, SRAM, DRAM, ROM, EPROM, memory chips or cartridges, etc. Computer programming code may be permanently or temporarily stored in the memory storage module 320, for example. In some embodiments, the computer memory storage module 320 may include a cache memory where files can be temporarily stored.

The electronic device 300 may also include a computer processing module 330. The computer processing module 330 may contain one or more central processing units (CPUs), graphics processing units (GPUs), or digital signal processors (DSPs), which may each be implemented using various digital circuit blocks (including logic gates such as AND, OR, NAND, NOR, XOR gates, etc) along with certain software code. The computer processing module 330 may be used to execute the computer programming code stored in the memory storage module 320.

The electronic device 300 may also include an input/output module 340, which may serve as a communications interface for the electronic device 300. In some embodiments, the input/output module 340 may include one or more touch-sensitive screens, physical and/or virtual buttons (such as power and volume buttons) on or off the touch-sensitive screen, physical and/or virtual keyboards, mouse, track balls, speakers, microphones, light-sensors, light-emitting diodes (LEDs), communications ports (such as USB or HDMI ports), joy-sticks, image-capture devices (for example cameras), etc. In some embodiments, the touch-sensitive screen may be used to display visual objects discussed above. The adaptive orientation switching and zooming level application according to the various embodiments discussed above may also be accomplished at least in part using the touch-sensitive screen and/or other components of the input/output module 340. In alternative embodiments, a non-touch screen display may be implemented as a part of the input/output module 340.

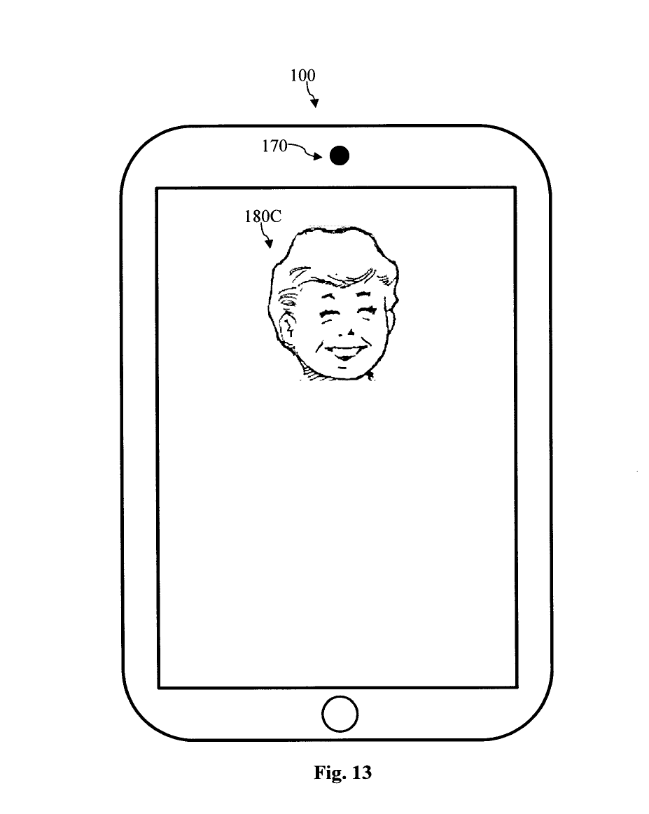

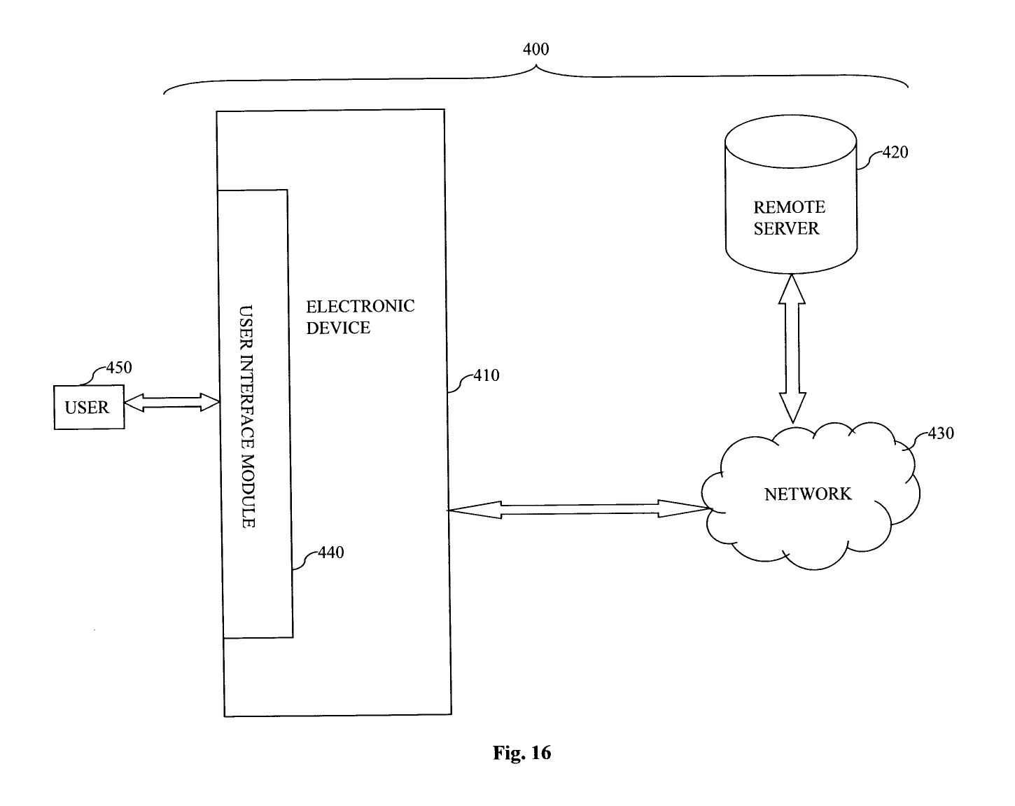

FIG. 16 is a simplified diagrammatic view of a system 400 that may be used to perform certain aspects of the adaptive orientation switching and zooming level application of the present disclosure discussed above. In some embodiments, the system 400 may include an electronic device 410. The electronic device 410 may be implemented as an embodiment of the electronic device 300 of FIG. 13. In some embodiments, the electronic device 410 includes a tablet computer or a mobile telephone.

The system 400 also includes a remote server 420. The remote server 420 may be implemented in a “cloud” computing environment and may include one or more databases that store files, for example the user preferences with respect to display orientations and/or zooming levels for a particular visual object.

The electronic device 410 and the remote server 420 may be communicatively coupled together through a network 430. The network 430 may include cellular towers, routers, switches, hubs, repeaters, storage units, cabling (such as fiber-optic cabling or telephone cabling), and other suitable devices. The network 430 may be implemented using any of the suitable wired or wireless networking protocols. The electronic device 410 and the remote server 420 may also be able to communicate with other devices on the network 430 and either carry out instructions received from the network, or send instructions through the network to these external devices to be carried out.

To facilitate user interaction with its offered services, a service provider (that hosts or operates the remote server 420) may provide a user interface module 440. The user interface module 440 may include software programming code and may be installed on the electronic device 410 (for example in a memory storage module). In some embodiments, the user interface module 440 may include a downloadable “app”, for example an app that is downloadable through a suitable service such as APPLE's® ITUNES®, THE APP STORE® from APPLE®, ANDROID's® PLAY STORE®, AMAZON's® INSTANT VIDEO®, MICROSOFT's® WINDOWS STORE®, RESEARCH IN MOTION's® BLACKBERRY APP WORLD®, etc. In the embodiment shown, the user interface module 440 includes an instance of the “app” that has been downloaded and installed on the electronic device 440. The app may also be used to estimate a user's preferences for display orientation and zooming level of a visual object, and to facilitate the subsequent display of that visual object according to the user's preferences.

A user 450 may interact with the system 400 by sending instructions to the electronic device 410 through the user interface module 440. For example, the user 450 may be a subscriber of the services offered by the service provider running/hosting/operating the remote server 420. The user 450 may attempt to log in to the remote server 420 by launching the “app” of the user interface 440. The user's login credentials are electrically sent to the remote server 420 through the network 430. After verifying the user login credentials, the remote server 420 may instruct the user interface module 440 to display a suitable interface to interact with the user in a suitable manner.

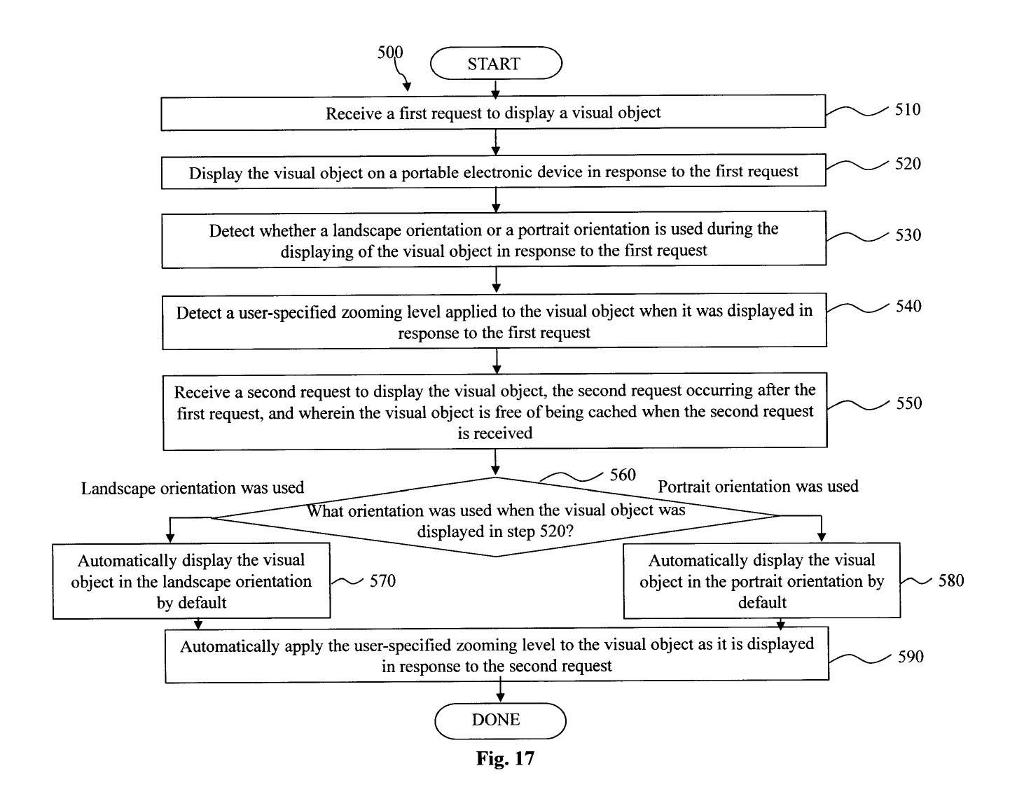

FIG. 17 is a flowchart of an example method 500 for configuring a visual display. The method includes a step 510, in which a first request to display a visual object is received. In some embodiments, the visual object includes one of: a webpage, a picture, a video, and a home screen containing a plurality of icons. The first request is received from a user. In some embodiments, the user may have a plurality of profiles, wherein each profile is configured to separately interact with a portable electronic device discussed below.

The method 500 includes a step 520, in which the visual object is displayed on a portable electronic device in response to the first request. The portable electronic device includes one of: a tablet computer and a mobile telephone. In some embodiments, the tablet computer and the mobile telephone each include one or more sensors. The one or more sensors include accelerometers, gyroscopes, gravity sensors, image sensors, and proximity sensors. The input from the user includes an input directed toward at least one of the one or more sensors. The visual object is displayed in one of the landscape and portrait orientations in response to an input from the user that is received by the portable electronic. In some embodiments, the visual object is among one or more frequently-accessed objects by a user. The frequently-accessed objects include objects that have been accessed by the user for more than an X number of times within a Y period of time prior to the first access request is received, both X and Y being predefined numbers.

The method 500 includes a step 530, in which whether a landscape orientation or a portrait orientation is used during the displaying of the visual object in response to the first request is detected.

The method 500 includes a step 540, in which a user-specified zooming level that is applied to the visual object when it was displayed in response to the first request is detected.

The method 500 includes a step 550, in which a second request to display the visual object is received. The second request occurs after the first request and is received from the same user who made the first request. The visual object is free of being cached when the second request is received. In some embodiments, the visual object is no longer stored in a cache memory of the portable electronic device when the second request is received. In some embodiments, the portable electronic device has been powered off at least once between the receiving the first request and the receiving the second request. In some embodiments, an application containing the visual object has been closed at least once between the receiving the first request and the receiving the second request.

The method 500 proceeds to a decision step 560 to determine whether the landscape orientation was used or the portrait orientation was used when the visual object was displayed in step 520. If the answer is that the landscape orientation was used, then the method 500 proceeds to step 570, in which the visual object is automatically displayed in the landscape orientation by default in response to the second request. If the answer from the decision step 560 is that the portrait orientation was used, then the method 500 proceeds to step 580, in which the visual object is automatically displayed in the portrait orientation by default in response to the second request.

The method 500 also includes a step 590, in which the user-specified zooming level is automatically applied to the visual object as it is displayed in response to the second request.

In some embodiments, the steps 570, 580, and 590 are performed only if the first request and the second request both originate from the same profile of the user.

It is understood that the method 500 may include additional steps performed before, during, or after the steps 510-590 discussed above. For example, the method 500 may further include the following steps: displaying the visual object a plurality of times on the portable electronic in response to a plurality of requests; detecting whether the landscape orientation or the portrait orientation is used during the displaying of the visual object in response to each of the requests; determining, based on the detected landscape or portrait orientation used during the displaying of the visual objects in response to each of the requests, a pattern with respect to an association between the displaying of the visual object with a preferred one of the landscape orientation and the portrait orientation; and automatically displaying the visual object in the preferred one of the landscape orientation and the portrait orientation in response to subsequent requests to display the visual object. Though additional steps may be performed for the method 500, these other additional steps are not described in detail herein for reasons of simplicity.

One aspect of the present disclosure involves a portable electronic device. The portable electronic device includes: a communications interface configured to display information; a memory storage component configured to store computer programming code; and a computer processor configured to execute the computer programming code to perform the following: receiving a first request to display a visual object; displaying the visual object on the portable electronic device in response to the first request; detecting whether a landscape orientation or a portrait orientation is applied to the visual object as it is displayed; receiving a second request to display the visual object, the second request occurring after the first request, wherein the visual object is free of being cached when the second request is received; and performing, in response to the second request, one of the following actions based on the detecting: if the landscape orientation is detected while the visual object is displayed in response to the first request, automatically displaying the visual object in the landscape orientation by default; and if the portrait orientation is detected while the visual object is displayed in response to the first request, automatically displaying the visual object in the portrait orientation by default.

In some embodiments, the memory storage component includes a cache memory element for temporarily storing digital data; and the visual object is not stored in the cache memory element when the second request is received.

In some embodiments, the portable electronic device has been powered off at least once between the receiving the first request and the receiving the second request.

In some embodiments, an application containing the visual object has been closed at least once between the receiving the first request and the receiving the second request.

In some embodiments, the visual object includes one of: a webpage, a picture, a video, and a home screen layout of the portable electronic device, the home screen layout containing a plurality of icons.

In some embodiments, the computer programming code, when executed, further perform: detecting a user-specified zooming level applied to the visual object when it was displayed in response to the first request; and automatically applying the user-specified zooming level to the visual object as it is displayed in response to the second request.

In some embodiments, the first request and the second request are each received from a user; and the visual object is applied one of the landscape and portrait orientations in response to the first request based on an input from the user that is sensed by one or more sensors of the portable electronic.

In some embodiments, the one or more sensors include accelerometers, gyroscopes, gravity sensors, image sensors, and proximity sensors.

In some embodiments, the user has a plurality of profiles, each of which is configured to separately interact with the portable electronic device; and the performing of the one of the following actions is carried out only if the first request and the second request both originate from the same profile of the user.

In some embodiments, the computer programming code, when executed, further perform: displaying the visual object a plurality of times on the portable electronic in response to a plurality of requests; detecting whether the landscape orientation or the portrait orientation is applied to the visual object each time it is displayed in response to the requests; determining, based on the detected landscape or portrait orientation applied to the visual object each time it is displayed in response to the requests, a user-preferred orientation mode for the visual object, the user-preferred orientation mode specifying whether the landscape orientation or the portrait orientation is preferred for the visual object; and automatically applying the user-preferred orientation mode as a default orientation mode for subsequent displays of the visual object.

In some embodiments, the visual object is among one or more frequently-accessed objects by a user; and the frequently-accessed objects include objects that have been accessed by the user for more than an X number of times within a Y period of time prior to the first access request is received, both X and Y being predefined numbers.

In some embodiments, the portable electronic device includes one of: a tablet computer and a mobile telephone.

In some embodiments, the communications interface includes a touch screen display of the tablet computer and the mobile telephone.

Another aspect of the present disclosure involves a method of configuring a visual display. The method includes: receiving a first request to display a visual object; displaying the visual object on a portable electronic device in response to the first request; detecting whether a landscape orientation or a portrait orientation is used during the displaying of the visual object in response to the first request; receiving a second request to display the visual object, the second request occurring after the first request, and wherein the visual object is free of being cached when the second request is received; and performing, in response to the second request, one of the following actions based on the detecting: if the landscape orientation is used during the displaying of the visual object in response to the first request, automatically displaying the visual object in the landscape orientation by default; and if the portrait orientation is used during the displaying of the visual object in response to the first request, automatically displaying the visual object in the portrait orientation by default.

In some embodiments, the visual object is no longer stored in a cache memory of the portable electronic device when the second request is received.

In some embodiments, the portable electronic device has been powered off at least once between the receiving the first request and the receiving the second request.

In some embodiments, an application containing the visual object has been closed at least once between the receiving the first request and the receiving the second request.

In some embodiments, the visual object includes one of: a webpage, a picture, a video, and a home screen containing a plurality of icons.

In some embodiments, the method further includes: detecting a user-specified zooming level applied to the visual object when it was displayed in response to the first request; and automatically applying the user-specified zooming level to the visual object as it is displayed in response to the second request.

In some embodiments, the first request and the second request are each received from a user; and the visual object is displayed in one of the landscape and portrait orientations in response the first request based on an input from the user that is received by the portable electronic.

In some embodiments, the user has a plurality of profiles, each of which is configured to separately interact with the portable electronic device; and the performing of the one of the following actions is carried out only if the first request and the second request both originate from the same profile of the user.

In some embodiments, the portable electronic device includes one of: a tablet computer and a mobile telephone. The tablet computer and the mobile telephone each include one or more sensors. The input from the user includes an input directed toward at least one of the one or more sensors. The one or more sensors include accelerometers, gyroscopes, gravity sensors, image sensors, and proximity sensors.

In some embodiments, the method further includes: displaying the visual object a plurality of times on the portable electronic in response to a plurality of requests; detecting whether the landscape orientation or the portrait orientation is used during the displaying of the visual object in response to each of the requests; determining, based on the detected landscape or portrait orientation used during the displaying of the visual objects in response to each of the requests, a pattern with respect to an association between the displaying of the visual object with a preferred one of the landscape orientation and the portrait orientation; and automatically displaying the visual object in the preferred one of the landscape orientation and the portrait orientation in response to subsequent requests to display the visual object.

In some embodiments, the visual object is among one or more frequently-accessed objects by a user; and the frequently-accessed objects include objects that have been accessed by the user for more than an X number of times within a Y period of time prior to the first access request is received, both X and Y being predefined numbers.

Yet another aspect of the present disclosure involves an apparatus comprising a non-transitory, tangible machine-readable storage medium storing a computer program. The computer program contains machine-readable instructions that when executed electronically by processors, perform: receiving a first request to display a visual object on a touch screen display of a portable electronic device, the visual object including at least one of: a webpage, a picture, a video, and a home screen layout of the portable electronic device; displaying the visual object on a touch screen display of the portable electronic device in response to the first request; detecting, using one or more sensors of the portable electronic device, a user-specified zoom level and an orientation mode applied to the visual object during the displaying, wherein the orientation mode is one of: a landscape orientation or a portrait orientation; receiving a second request to display the visual object, the second request occurring sufficiently long after the first request such that the visual object is no longer stored in a cached memory of the portable electronic device when the second request is received; and displaying, in response to the second request, the visual object with the detected user-specified zoom level and the orientation mode by default.

In some embodiments, the portable electronic device has been powered off at least once between the receiving the first request and the receiving the second request.

In some embodiments, an application containing the visual object has been closed at least once between the receiving the first request and the receiving the second request.

In some embodiments, the one or more sensors include accelerometers, gyroscopes, gravity sensors, image sensors, and proximity sensors.

In some embodiments, the first and second requests are received from a user having a plurality of profiles, each of the profiles being configured to separately interact with the portable electronic device; and the visual object is displayed by default with the detected user-specified zoom level and the orientation mode only if the first request and the second request both originate from the same profile of the user.

In some embodiments, the visual object is among one or more frequently-accessed objects by a user; and the frequently-accessed objects include objects that have been accessed by the user for more than an X number of times within a Y period of time prior to the first access request is received, both X and Y being predefined numbers.

It should be appreciated that like reference numerals in the present disclosure are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A portable electronic device, comprising:
a communications interface configured to display information;
a memory storage component configured to store computer programming code; and
a computer processor configured to execute the computer programming code to perform the following:
receiving a first request to display a visual object;
displaying the visual object on the portable electronic device in response to the first request;
detecting whether a landscape orientation or a portrait orientation is applied to the visual object as it is displayed;
receiving a second request to display the visual object, the second request occurring after the first request, wherein the visual object is free of being cached when the second request is received; and
performing, in response to the second request, one of the following actions based on the detecting:
if the landscape orientation is detected while the visual object is displayed in response to the first request, automatically displaying the visual object in the landscape orientation by default; and
if the portrait orientation is detected while the visual object is displayed in response to the first request, automatically displaying the visual object in the portrait orientation by default.

2. The portable electronic device of claim 1, wherein:
the memory storage component includes a cache memory element for temporarily storing digital data; and
the visual object is not stored in the cache memory element when the second request is received.

3. The portable electronic device of claim 1, wherein at least one of the following is true:
the portable electronic device has been powered off at least once between the receiving the first request and the receiving the second request; and
an application containing the visual object has been closed at least once between the receiving the first request and the receiving the second request.

4. The portable electronic device of claim 1, wherein the visual object includes one of: a webpage, a picture, a video, and a home screen layout of the portable electronic device, the home screen layout containing a plurality of icons.

5. The portable electronic device of claim 1, wherein the computer programming code, when executed, further perform:
detecting a user-specified zooming level applied to the visual object when it was displayed in response to the first request; and
automatically applying the user-specified zooming level to the visual object as it is displayed in response to the second request.

6. The portable electronic device of claim 1, wherein:
the first request and the second request are each received from a user;
the user has a plurality of profiles, each of which is configured to separately interact with the portable electronic device; and
the performing of the one of the following actions is carried out only if the first request and the second request both originate from the same profile of the user.

7. The portable electronic device of claim 1, wherein the computer programming code, when executed, further perform:
displaying the visual object a plurality of times on the portable electronic in response to a plurality of requests;
detecting whether the landscape orientation or the portrait orientation is applied to the visual object each time it is displayed in response to the requests;
determining, based on the detected landscape or portrait orientation applied to the visual object each time it is displayed in response to the requests, a user-preferred orientation mode for the visual object, the user-preferred orientation mode specifying whether the landscape orientation or the portrait orientation is preferred for the visual object; and
automatically applying the user-preferred orientation mode as a default orientation mode for subsequent displays of the visual object.

8. The portable electronic device of claim 1, wherein:
the visual object is among one or more frequently-accessed objects by a user; and
the frequently-accessed objects include objects that have been accessed by the user for more than an X number of times within a Y period of time prior to the first access request is received, both X and Y being predefined numbers.

9. The portable electronic device of claim 1, wherein:
the portable electronic device includes one of: a tablet computer and a mobile telephone; and
the communications interface includes a touch screen display of the tablet computer and the mobile telephone.

10. A method of configuring a visual display, comprising:
receiving a first request to display a visual object, wherein the visual object includes one of: a webpage, a picture, a video, and a home screen containing a plurality of icons;
displaying the visual object on a portable electronic device in response to the first request;
detecting whether a landscape orientation or a portrait orientation is used during the displaying of the visual object in response to the first request;
receiving a second request to display the visual object, the second request occurring after the first request, wherein the visual object is no longer stored in a cache memory of the portable electronic device when the second request is received; and
performing, in response to the second request, one of the following actions based on the detecting:
if the landscape orientation is used during the displaying of the visual object in response to the first request, automatically displaying the visual object in the landscape orientation by default; and
if the portrait orientation is used during the displaying of the visual object in response to the first request, automatically displaying the visual object in the portrait orientation by default.

11. The method of claim 10, wherein at least one of the following is true:
the portable electronic device has been powered off at least once between the receiving the first request and the receiving the second request; and
an application containing the visual object has been closed at least once between the receiving the first request and the receiving the second request.

12. The method of claim 10, further comprising:
detecting a user-specified zooming level applied to the visual object when it was displayed in response to the first request; and
automatically applying the user-specified zooming level to the visual object as it is displayed in response to the second request.

13. The method of claim 10, wherein:
the first request and the second request are each received from a user having a plurality of profiles, each of which is configured to separately interact with the portable electronic device; and
the performing of the one of the following actions is carried out only if the first request and the second request both originate from the same profile of the user.

14. The method of claim 10, further comprising:
displaying the visual object a plurality of times on the portable electronic in response to a plurality of requests;
detecting whether the landscape orientation or the portrait orientation is used during the displaying of the visual object in response to each of the requests;
determining, based on the detected landscape or portrait orientation used during the displaying of the visual objects in response to each of the requests, a pattern with respect to an association between the displaying of the visual object with a preferred one of the landscape orientation and the portrait orientation; and
automatically displaying the visual object in the preferred one of the landscape orientation and the portrait orientation in response to subsequent requests to display the visual object.

15. The method of claim 10, wherein:
the visual object is among one or more frequently-accessed objects by a user; and
the frequently-accessed objects include objects that have been accessed by the user for more than an X number of times within a Y period of time prior to the first access request is received, both X and Y being predefined numbers.

16. An apparatus comprising a non-transitory, tangible machine-readable storage medium storing a computer program, wherein the computer program contains machine-readable instructions that when executed electronically by processors, perform:
receiving a first request to display a visual object on a touch screen display of a portable electronic device, the visual object including at least one of: a webpage, a picture, a video, and a home screen layout of the portable electronic device;
displaying the visual object on a touch screen display of the portable electronic device in response to the first request;
detecting, using one or more sensors of the portable electronic device, a user-specified zoom level and an orientation mode applied to the visual object during the displaying, wherein the orientation mode is one of: a landscape orientation or a portrait orientation;
receiving a second request to display the visual object, the second request occurring sufficiently long after the first request such that the visual object is no longer stored in a cached memory of the portable electronic device when the second request is received; and
displaying, in response to the second request, the visual object with the detected user-specified zoom level and the orientation mode by default.

17. The apparatus of claim 16, wherein at least one of the following is true:
the portable electronic device has been powered off at least once between the receiving the first request and the receiving the second request; and
an application containing the visual object has been closed at least once between the receiving the first request and the receiving the second request.

18. The apparatus of claim 16, wherein the one or more sensors include accelerometers, gyroscopes, gravity sensors, image sensors, and proximity sensors.

19. The apparatus of claim 16, wherein:
the first and second requests are received from a user having a plurality of profiles, each of the profiles being configured to separately interact with the portable electronic device; and
the visual object is displayed by default with the detected user-specified zoom level and the orientation mode only if the first request and the second request both originate from the same profile of the user.

20. The apparatus of claim 16, wherein:
the visual object is among one or more frequently-accessed objects by a user; and
the frequently-accessed objects include objects that have been accessed by the user for more than an X number of times within a Y period of time prior to the first access request is received, both X and Y being predefined numbers.
